(19) United States
(12) Patent Application Publication
(10) Pub. No.: US 2001/0016872 A1
(43) Pub. Date: Aug. 23, 2001

(54) Information control system, information processing support server, information processing terminal, information processing method, storage storing information processing program, and program transmission apparatus

(76) Inventor: Rika Kusuda, Yamato-shi (JP)

Correspondence Address: Ronald L. Drumheller, Esq., 94 Teakettle Spout Road, Mahopac, NY, 10541, US

(21) Appl. No.: 09/727,083

(22) Filed: Nov. 30, 2000

(30) Foreign Application Priority Data
Nov. 30, 1999 (JP) 11-341459

(51) Int. Cl. G06F 15/16

(52) U.S. Cl. 709/205; 709/206; 709/219

(57) ABSTRACT

An information Control system makes it possible for a plurality of users to share attached-information by registering the attached-information, which is added to WWW contents, in a server by associating the attached-information with the WWW contents. The information control system includes an information processing support server 100, and a plurality of information processing terminals 200 that obtain WWW contents via this information processing support server 100 and perform work using these WWW contents, the information processing terminal 200 including a client application 220 adding attached-information to the WWW contents obtained, the information processing support server 100 including a cache manager 122 retaining the attached-information, added to the WWW contents, and a URL of the WWW contents by associating them with each other, and a URL list selector 124 transmitting a Web content, having this URL, and the attached-information, associated with this URL, to an information processing terminal if an access request from the information processing terminal corresponds to the URL retained.

### DESCRIPTION

1. Field of the Invention

The present invention relates to an information processing method for supporting collaboration for which WWW (Web) contents are used and which is performed by a plurality of clients.

2. Related Art

Today, in the WWW widely used in the Internet, collaboration technology is proposed, the collaboration technology with which a plurality of users perform collaboration (access, movement, modification, etc.) on Web-page. FIG. 14 is a diagram showing an example of applying this collaboration on Web-page to customer counseling service. In this service, a customer terminal 1410 which a customer uses and an agent terminal 1420 that an agent corresponding to customer's consultation uses are connected via a communication network. In a state shown in FIG. 14, the customer terminal 1410 and agent terminal 1420 display Web-pages 1411 and 1421 that are the same. Here, since the customer terminal 1410 and agent terminal 1420 are synchronized by software providing the collaboration, an operation which the customer performs on the Web-page 1411 by using the customer terminal 1410 is reflected in the Web-page 1421 displayed in the agent terminal 1420. Similarly, an operation which the agent performs on the Web-page 1421 by using the agent terminal 1420 is reflected in the Web-page 1411 displayed in the customer terminal 1410. Therefore, by the customer and agent performing operations such as mutual writing on the same Web-page, it becomes possible to provide such service that the agent corresponds to customer's consultation.

A premise of such collaboration technology is that a plurality of users performing collaboration join a session of the collaboration simultaneously. Thus, in the example of the customer counseling service, in order to receive the service by collaboration, it is necessary that the customer terminal 1410 and agent terminal 1420 are connected to each other, and both perform operations with referring to the same page simultaneously. Nevertheless, it is not always possible that a suitable agent familiar with the contents of a question corresponds to the question if the customer questions in such cases that the agent corresponds to a plurality of customers in a Call Center and that the question occurs out of office hours. Therefore, it is not always possible to effectively and sufficiently use the service using the technology.

By the way, in public networks such as the Internet, it is forbidden from the viewpoint of their publicness for a user to arbitrarily add or modify information on the networks. On the other hand, Published Unexamined Patent Application No. 10-21263, the technology of adding user's unique information is proposed, the technology, which is realized by associating additional data with main data without modifying the main data registered in a network. Owing to this, the user can perform an operation such as addition of annotation data to Web-page that the user accesses.

### SUMMARY OF THE INVENTION

In this manner, in the conventional collaboration technology, it is necessary that a plurality of users join a session of the collaboration simultaneously. Therefore, it is not possible to effectively use the collaboration technology depending on a use mode of the collaboration technology like the customer counseling service described above, and hence it is not possible to obtain a sufficient effect.

In consideration of such problems, a method is conceivable, the method which is such a method that a user informs an agent of the contents of a question via an e-mail or the like beforehand, and the agent who can suitably correspond to the question selects a time, when the agent can correspond, to establish a collaboration session. Nevertheless, since it is necessary to read the e-mails and understand their contents, so as to sort questions, sent via e-mails, for suitable agents, work becomes complicated. In addition, it is sometimes difficult to accurately inform an agent of the contents of a question only in a sentence.

If the conventional technology associating attached-information with the Web-page described above can be used so as to accurately express the contents of the question, it is convenient since it is possible to add information such as indicating a questionable place directly with an arrow.

The present invention is intended to solve the above technical subjects, and an object of the present invention is to make it possible for a plurality of users to share attached-information added to WWW contents, and to refer to or modify the WWW contents with the attached-information at any time.

In addition, another object is to make it possible to automatically deliver the WWW contents with attached-information to predetermined users.

Furthermore, still another object is to make it possible for a user to generate a URL list and easily access the WWW contents with attached-information.

For these objects, the present invention provides an information control system supporting the collaboration for which a Web content are used and which is performed with a plurality of information processing terminals, the information control system comprising an information processing support server connected to Web server via a communication network, and the plurality of information processing terminals that obtain the Web content, provided by the Web server via the information processing support server, and perform work using this WWW contents, the information processing terminal comprising an attached-information adding-section adding predetermined attached-information to the Web content obtained, the information processing support server comprising an attached-information managing section retaining the attached-information, added to the Web content by the information processing terminal, and a URL of the Web content with associating them with each other, and an attached-information transmitter transmitting the Web content, having this URL, and the attached-information, associated with this URL, to an information processing terminal if an access request from the information processing terminal corresponds to the URL retained in this attached-information managing-section.

The transmission and reception of data between this information processing support server and information processing terminal can be performed, for example, via a TCP/IP network. Therefore, it is possible to perform, for example, communication itself between the information processing support server and information processing terminal via various types of networks such as dial-up connection by using a public telephone network, and a LAN installed in a company.

In addition, an information control system is characterized in that this information control system includes at least annotation data for performing drawing on the Web content as attached-information, in the information processing support server, the attached-information managing-section associates a URL of the Web content with a file name of the annotation data, and the attached-information transmitter transmits the Web content, relating to an access request, and the annotation data, being specified with the file name associated with the URL of the Web content, to an information processing terminal according to the access request from the information processing terminal, and the information processing terminal synthesizes and displays the Web content and annotation data by using a browser. According to this configuration, it becomes possible to realize the sharing of annotation data even if the annotation data is added as attached-information to a Web content, and to reproduce the annotation data, which is added, when displaying the Web content.

Furthermore, this information control system is characterized in that this information control system includes at least data filled in a form for the Web content as attached-information, in the information processing support server, the attached-information managing-section associates a URL of the Web content with the data itself filled in the form, and the attached-information transmitter embeds the data, which is filled and is associated with the URL of this a Web content, in a form of the Web content relating to an access request according to the access request from an information processing terminal and transmits the Web content to the information processing terminal, and the information processing terminal displays the Web content, in the form of which the filled data is embedded, by using a browser. According to this configuration, it becomes possible to realize the sharing of filled data even if the data is filled in the form of a Web content, and to reproduce the Web content in such a state that the data is filled.

Moreover, an information processing support server further comprises a URL list generator generating a URL list of a Web content, characterized in that attached-information is added, according to a request from an information processing terminal, and a URL list transmitting the URL list, which is generated, to the information processing terminal. According to this configuration, since it is possible to take a look at a Web content, where attached-information is added, in an information processing terminal, this is excellent at a point of being capable of selectively accessing one of such a Web content.

This information control system is characterized in that the URL list generator in this information processing support server generates a URL list as a Web content, and the information processing terminal requests the information processing support server to obtain a Web content, where attached-information is added, by clicking a desired URL in this URL list provided as a Web content. According to this configuration, this is preferable at a point of being capable of accessing desired a Web content by using a simple method that is similar to an access to a link page in usual a Web content such as a home page.

In addition, if this information control system is characterized in that the URL list generator in the information processing support server recognizes a user of the information processing terminal, and generates a URL list of the Web content that this user can access, this is preferable at a point of being capable of easily providing means for performing collaboration only between specific users.

Furthermore, if this information control system is characterized in that the URL list generator in the information processing support server sets a Web content, which a user can access, on the basis of a kind of the Web content of attached-information, it is possible to arbitrarily set users performing collaboration.

The present invention provides an information control system supporting collaboration for which a Web content are used and which is performed with a plurality of information processing terminals, the information control system comprising the plurality of information processing terminals each of which is connected to Web server via a communication network, obtains a Web content provided by the Web server, and adds predetermined attached-information as work for the Web content, and an information processing support server that associates the attached-information, added to the Web content by the information processing terminal, with a URL of this a Web content and retains them, this information processing support server returning the attached-information corresponding to an access request to the information processing terminal at the time of receiving the access request, corresponding to a URL associated with the attached-information, from the information processing terminal, this information processing terminal receiving this attached-information from the information processing support server, obtaining a Web content having the URL corresponding to this access request from the Web server, and synthesizing this attached-information and the Web content. According to this configuration, this is preferable at a point of being capable of adding attached-information even to a Web content that an information processing terminal directly obtains without intervention of an information processing support server.

The present invention provides a following information processing support server supporting collaboration for which a Web content are used and which is performed with a plurality of information processing terminals. Thus, this information processing support server comprises a cache manager obtaining a Web content from Web server, connected to a communication network, according to an access request from an information processing terminal, transmitting the Web content, which are obtained, to the information processing terminal having issued the access request, and a session information controller recognizing the start of a session by the information processing terminal owing to the access request received from the information processing terminal, managing session information including a URL of a Web content that will be processed in this session, receiving attached-information added to the Web content by the information processing terminal, and managing this session information and this attached-information with associating them with each other.

Here, in the session recognized, the session information controller is characterized in that the session information controller allows a transmission and receiving section to transmit the Web content with the URL, included in this session information, and the attached-information, associated with this session information, to the information processing terminal if the access request from the information processing terminal corresponds to the session information. According to this configuration, users of information processing terminals accessing the Web content to which this attached-information is added can share such attached-information, and hence can participate in collaboration in which the Web content are used.

In addition, the session information controller is characterized in that the session information controller embeds filled data in a form of a Web content and allows a transmission and receiving section to transmit the Web content to the information processing terminal if the Web content obtained in the session recognized are a Web content with a form, and data filled in the form is associated with its URL as attached-information. According to this configuration, the session information controller is preferable at a point of being capable of performing collaboration in the shape of filling a comment into a Web content with a form, responding to the comment, or the like.

Furthermore, the information processing support server is characterized in that the information processing support server further comprises a URL list generator generating a URL list of a Web content as a Web content, to which attached-information is added, according to a request from an information processing terminal, and a cache manager returns the URL list, generated by this URL list generator, to the information processing terminal. According to this configuration, it is possible in an information processing terminal to take a glance of a Web content, to which attached-information is added, and to access each of a Web content, to which attached-information is added, by using a simple method similar to an access to a link page in usual a Web content. Therefore, this is excellent in a point of being capable of simply participating in collaboration.

The present invention provides the following information processing terminal. Thus, the information processing terminal comprises a connecting section for sending and receiving data including a Web content with being connected to Web server, and a browser displaying a Web content received from the server via this connecting section, adding predetermined attached-information to a Web content displayed, and transmitting a Web content to the server via the connecting section, this browser being capable of synthesizing and displaying a Web content and annotation data if the data received from the server is a Web content and annotation data as attached-information added to a Web content. In this manner, this becomes an excellent information processing terminal at a point of being capable of supporting the work of adding annotation data to a Web content or modifying the annotation data, as collaboration.

In addition, this browser is characterized in that this browser obtains annotation data by using a file name, synthesizes a Web content and annotation data, and displays them if the data received from the server is a Web content and the file name of annotation data as attached-information added to a Web content, and this annotation data can be obtained from predetermined storage apparatus except the Web server. According to this configuration, since it is not necessary to reproduce annotation data in the server, a response to an access becomes fast, and hence this is preferable at a point of being capable of performing collaboration in an environment further comfortable.

In addition, the present invention comprises a connecting section for transmitting and receiving data including a Web content with being connected to a server via a communication network, a synthesis processor obtaining a Web content with a URL via the communication network and synthesizing a Web content and attached-information at the time of receiving this attached-information, associated with a predetermined URL, from the server via this connecting section, and a browser displaying a Web content, which are received from the server via the connecting section and with which the attached-information is synthesized by the synthesis processor, adding predetermined attached-information to a Web content displayed, and transmitting a Web content to the server via the connecting section.

The present invention provides the following information processing method for supporting collaboration for which a Web content are used and which is performed with a plurality of information processing terminals. Thus, the information processing method includes a step of adding predetermined attached-information to a Web content, a step of associating the attached-information, added to a Web content, with a URL of a Web content and retaining them, and a step of transmitting a Web content, having the URL, and the attached-information, associated with the URL, to the source of the access request according to the access request corresponding to the URL associated with the attached-information.

Here, this information processing method is characterized in that at least annotation data for performing drawing on a Web content is included as attached-information at the step of adding attached-information, the step of retaining the attached-information includes a step of generating a data file after receiving annotation data and associating a file name of this data file with a URL of a Web content if the attached-information is the annotation data, and the step of adding attached-information to a Web content includes a step of adding the data file of annotation data specified by a file name to a Web content if information associated with the URL is this file name of the annotation data and further includes a step of synthesizing a Web content and the annotation data at the time of displaying a Web content. According to this configuration, even if annotation data is added as attached-information to a Web content, it is possible to reproduce the annotation data, which is added, at the time of displaying a Web content.

In addition, this information processing method is characterized in that at least data filled in a form of a Web content is included as attached-information at the step of adding attached-information, the step of retaining attached-information includes a step of associating data itself to a Web content if the attached-information is this data filled in the form, and the step of adding attached-information to a Web content includes a step of embedding the data, filled in a form, in a concerned place of a Web content having this form if information associated with a URL is the data filled in the form. According to such configuration, it is possible to display a Web content in such a state that data is filled if the data is filled in the form of a Web content.

In addition, before the step of adding attached-information, this information processing method is characterized by further comprising a step of generating a URL list of a Web content having attached-information that are associated at the step of retaining the attached-information. According to this configuration, this information processing method is preferable at a point of being capable of easily retrieving a Web content, where attached-information is added, by referring to this URL list.

Furthermore, the step of generating a URL list is characterized by including a step of recognizing users of information processing terminals, and a step of generating a URL list of a Web content that the users can access. According to this configuration, it is possible to perform collaboration only between specific users.

According to the present invention, a storage is provided, the storage, which stores an information processing program, executed by a computer, so that input means of the computer can read the information processing program. The information processing program stored in this storage is an information processing program making a computer execute the processing of obtaining a Web content from Web server, connected to a communication network, according to an access request from an information processing terminal and transmitting a Web content to the information processing terminal having issued the access request, the processing of receiving attached-information added to a Web content by the information processing terminal and retaining the attached-information and a Web content with associating them with each other, and the processing of adding this attached-information to a Web content and transmitting a Web content to the information processing terminal if the attached-information has already been associated with a URL of a Web content obtained according to the access request from the information processing terminal.

According to the present invention, a storage is provided, the storage, which stores an information processing program, executed by an information processing terminal, so that the input means of the information processing terminal can read the information processing program. The information processing program stored in this storage is an information processing program making the information processing terminal execute the processing of receiving a Web content from a server and displaying a Web content, the processing of synthesizing a Web content and annotation data before the display processing if the annotation data is added to a Web content received from the server, the processing of adding predetermined attached-information to a Web content displayed, and the processing of transmitting this attached-information, which is added, to the server. Owing to this, it becomes possible to use all the information processing terminals, in each of which such an information processing program can be installed, as terminals for performing collaboration.

According to the present invention, a storage is provided, the storage, which stores an information processing program, executed by an information processing terminal, so that the input means of the information processing terminal can read the information processing program. The information processing program stored in this storage is characterized by making the information processing terminal execute the processing of receiving attached-information associated with a predetermined URL by a server, the processing of obtaining a Web content having the URL corresponding to the attached-information received, the processing of synthesizing a Web content and attached-information that are obtained, and the processing of displaying a Web content where the attached-information is synthesized.

A program transmission apparatus to which the present invention is applied is characterized by comprising storage means for storing a program making an information processing terminal execute the processing of receiving a Web content from a server and displaying a Web content, the processing of synthesizing a Web content and annotation data before the display processing if the annotation data is added to a Web content received from the server, the processing of adding predetermined attached-information to a Web content displayed, and the processing of transmitting this attached-information, which is added, to the server, and transmission means for reading the program from this storage means and transmitting this program. Therefore, it becomes possible to use all the information processing terminals, into each of which such an information processing program can be down-loaded from this program transmission apparatus and can be installed, as terminals for performing collaboration.

An information control system according to the present invention comprises a plurality of information processing terminals and an information processing support server supporting collaboration for which a Web content are used and which is performed with this plurality of information processing terminals, and is characterized in that the information processing support server comprises storage means for storing a program executed by the plurality of information processing terminals, and transmission means for reading this program from the storage means according to a request from the information processing terminal and transmitting this program, the program which is stored in this storage means and makes the information processing terminal execute the processing of receiving a Web content and displaying a Web content, the processing of adding predetermined attached-information to a Web content displayed, the processing of transmitting this attached-information, which is added, to the information processing support server, and the processing of synthesizing a Web content and annotation data at the time of receiving a Web content and annotation data associated with this a Web content. According to such configuration, it becomes possible to use all the information processing terminals, each of which can access the information processing support server and down-load such an information processing program, which is installed in each of the plurality of information processing terminals, as terminals for performing collaboration supported by this information control system.

### BRIEF DESCRIPTION OF THE DRAWINGS

FIG. 1 is a diagram for explaining an entire configuration of an information control system in the present embodiment.

FIG. 2 is a flow chart for explaining operation in the present embodiment when attached-information is added to WWW contents, and a flow chart showing the operation of an information processing terminal establishing a session with an information processing support server.

FIG. 3 is a flow chart for explaining operation in the present embodiment when attached-information is added to WWW contents, and a flow chart showing the operation of attached-information being added to WWW contents that are a work object.

FIG. 4 is a flow chart for explaining operation in the present embodiment when WWW contents, to which attached-information is added, are reproduced, and a flow chart showing the operation of an information processing terminal establishing a session with an information processing support server at the time of accessing a URL list as well as a usual log-on.

FIG. 5 is a flow chart for explaining operation in the present embodiment when WWW contents, to which attached-information is added, are reproduced, and a flow chart showing the operation of adding attached-information to WWW contents and reproducing the attached-information.

FIG. 6 is a flow chart for explaining operation in the present embodiment when WWW contents, to which attached-information is added, are reproduced, and a flow chart showing the operation of accessing the WWW contents for generating a URL list.

FIG. 7 is a diagram for explaining the configuration of an access right control table.

FIG. 8 is a diagram for explaining the configuration of a URL attached-data control table.

FIG. 9 is a diagram for explaining the configuration of a condition list.

FIG. 10 is a diagram for explaining the configuration of a table mapping a UAI with a session ID.

FIG. 11 is a drawing showing an example of WWW contents (Web-page) in such a state that a customer user inputted attached-information.

FIG. 12 is a diagram showing an example of registration information in a URL attached-data control table including information relating to the session in FIG. 11.

FIG. 13 is a diagram showing an example of a URL list generated on the basis of the URL attached-data control table in FIG. 12.

FIG. 14 is a diagram for explaining conventional collaboration technology.

### DESCRIPTION OF THE PREFERRED EMBODIMENTS Hereinafter, this invention will be described in detail on the basis of embodiments shown in the drawings.

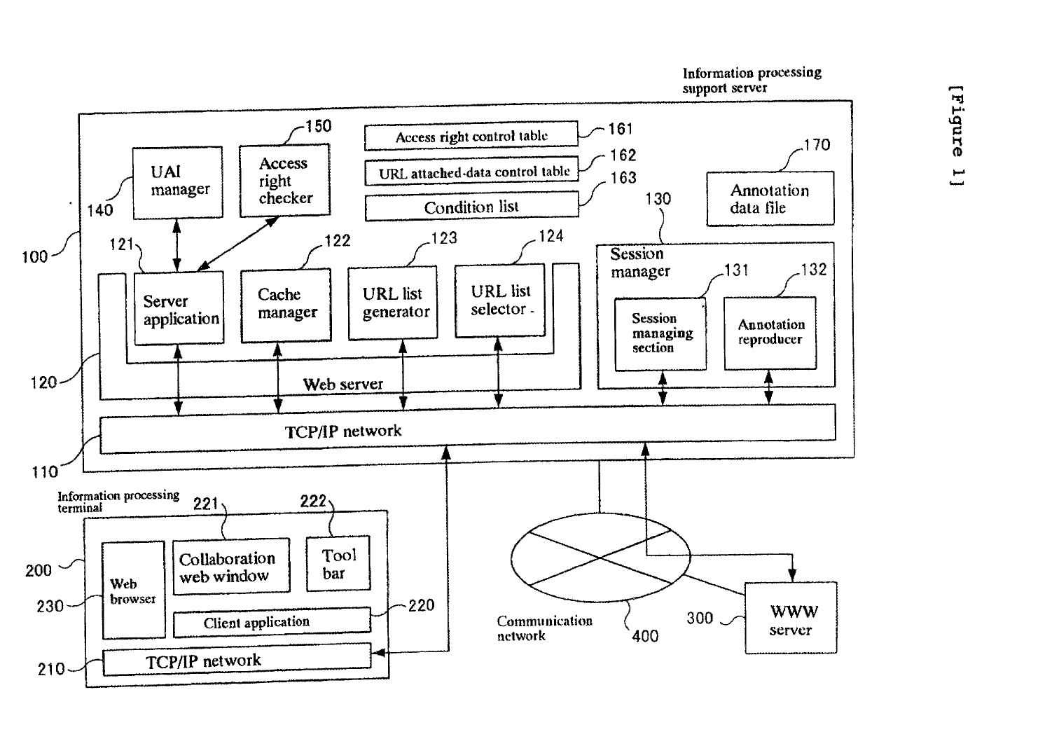

FIG. 1 is a diagram for explaining the entire configuration of an information control system in the present embodiment. In this diagram, numeral 100 denotes an information processing support server. This information processing support server 100 comprises a TCP/IP network 110, and is connected to a communication network 400 such as the Internet. Numeral 200 denotes an information processing terminal. This information processing terminal 200 comprises a TCP/IP network 210, and is connected to the information processing support server 100. In this embodiment, since it is assumed that a plurality of users share information added to WWW contents (hereinafter, this information added is called attached-information), actually, a plurality of information processing terminals are present. Nevertheless, since respective information processing terminals have the same configuration, only one information processing terminal 200 is shown in FIG. 1. In addition, the information processing terminal 200 and information processing support server 100 can be connected via a communication network 400. Numeral 300 denotes a WWW server. This WWW server 300 is connected to the communication network 400, and stores WWW contents (homepages or the like). The information processing terminal 200 accesses the WWW contents stored in the WWW server 300 via the information processing support server 100.

The information processing support server 100 comprises Web server 120, a server application 121 operating in the Web server 120, a cache manager 122, a URL list generator 123 and a URL list selector 124, a session manager 130, a UAI manager 140, and an access right checker 150. In addition, the information processing support server 100 comprises, as tables used for information processing, an access right control table 161 for controlling users' access rights, a URL attached-data control table 162 for controlling attached-information added to WWW contents, and a condition list 163 for setting conditions of WWW contents that users can refer to. Furthermore, the information processing support server 100 can be realized by an ordinary computer system having a communication function such as a personal computer or a workstation. Therefore, although this is not described in the drawing, as hardware configuration, the information processing support server 100 comprises a CPU, memory, an external storage apparatus such as a hard disk drive storing programs, operating in the CPU, and data such as various types of tables described above, and a connection interface for connecting the information processing support server 100 to the communication network 400, and further comprises various types of devices such as input devices like a keyboard or the like, and output devices like a display or the like according to necessity.

The server application 121 operating in the Web server 120 supports collaboration on WWW contents by the plurality of information processing terminals 200 with a client application 220 installed in the information processing terminal 200 described later. In addition, the server application 121 recognizes the start of a session by an access request from the information processing terminal 200, verifies a user's access right by using the access right checker 150, and obtains a UAI (User Access Identification) by using the UAI manager 140.

The cache manager 122 manages attached-information, which is added, when the attached-information is added to predetermined WWW contents in the information processing terminal 200. In addition, in this embodiment, it is assumed that the attached-information is data filled in a form and annotation data. Here, a “form” means “an object where text data can be filled by providing predetermined fields on WWW contents,” and “submit” means “transmit data, filled in the form, to the Web server 120.” In addition, “annotation data” means “graphic data visually added to WWW contents displayed by a browser.” Thus, by adding the annotation data, it is possible to visually perform drawing without modifying data itself of the WWW contents. Among these attached-information, data that is filled in the form and submitted (hereinafter, this is called form data) is retained in the cache manager 122. Furthermore, the annotation data is retained in the session manager 130 under the control of the cache manager 122.

In this embodiment, the attached-information is managed by using the URL attached-data control table 162. The URL attached-data control table 162 is generated by the cache manager 122 when the server application 121 recognizes the start of a session by an access request from the information processing terminal 200. Then, as shown in FIG. 8, a session ID, a user's log-on ID, date and time when the session was performed, and information such as a URL, attached-Information, and a transaction name of the WWW contents, which is an object of work, are registered in each line of the URL attached-data control table 162. Here, the “session ID” means “ID information for specifying a session supported by the information processing support server 100.” The “log-on ID” does “ID information for specifying a user.” As the attached-information, if form data is added, the form data itself is registered. In addition, if annotation data is added, only a file name of the annotation data is registered, and the annotation data is made to be retained in the session manager 130. In this manner, although, in this embodiment, only the form data and annotation data is exemplified, it is possible to add various data as the attached-information by taking a style of being capable of managing objects besides the form data and annotation data by the cache manager 122. Moreover, also when attached-information is added on the way to an original destination to the same URL (WWW contents) and subsequent work is freshly performed, it becomes possible to easily recognize at what stage the attached-information is by registering a name of the work at this time as a transaction name.

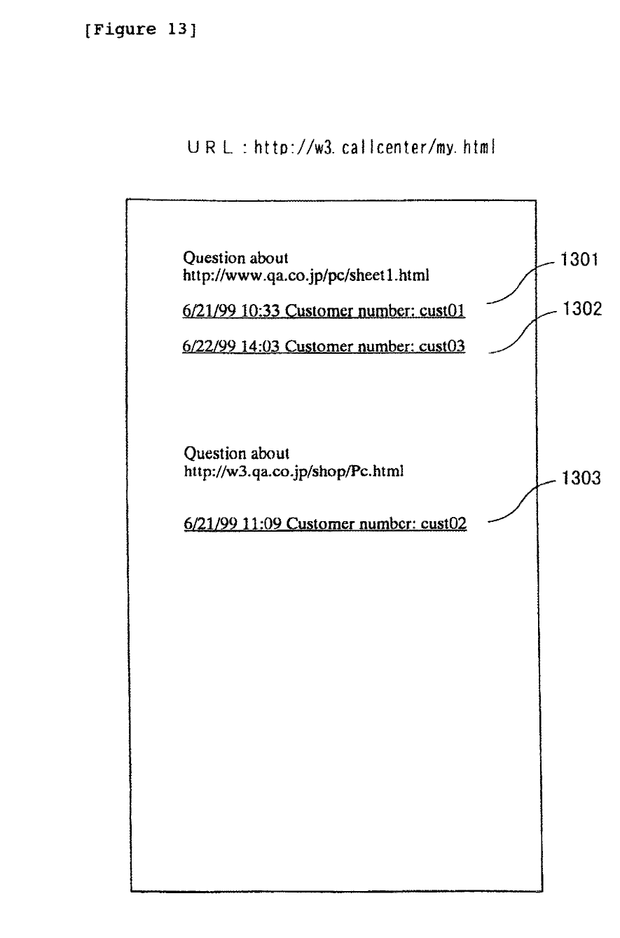

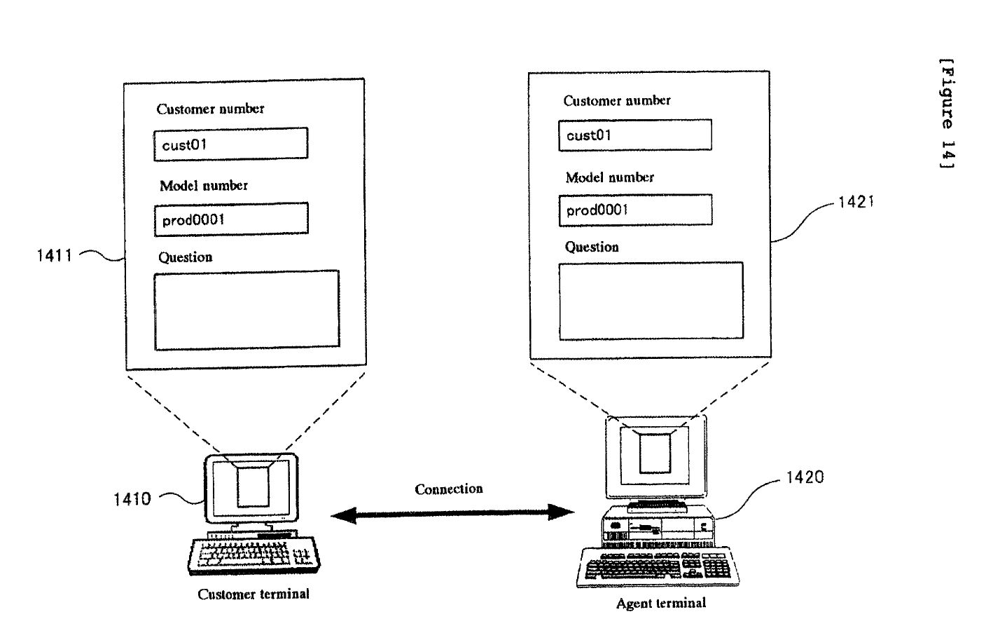

The URL list generator 123 generates a URL list of WWW contents where attached-information is added by a CGI program according to a request from the information processing terminal 200. The URL list is generated as WWW contents as shown in FIG. 13 by using, for example, a format of HTML. Owing to this, by displaying the URL list in the information processing terminal 200 as described later, it is possible to access the WWW contents of the URL by clicking the desired URL.

Here, the URL list generator 123 recognizes a user of the information processing terminal 200 who issued a URL list generation request, and generates the URL list with making only the WWW contents, which the user can access, as an object. In this embodiment, the condition list 163 is used for decision of the WWW contents, which the user can access when the URL list is generated. The condition list 163 is generated beforehand and is stored in the storage apparatus, which is not shown, in the information processing support server 100. Then, by referring to the condition list 163 when the URL list generator 123 generates the URL list, it becomes possible to restrict URLs, which are listed, according to the user who is logged on.

As shown in FIG. 9, information such as a user's log-on ID, a URL of WWW contents (an assigned URL), a customer ID, date and time when the session was opened, or the like are registered in each line of the condition list 163. Then, it is possible to set conditions of listing only the URLs, in which each user is registered, for the user having a predetermined log-on ID, listing a URL concerned only when attached-information is added by each user having a customer ID registered, listing only URLs where a session is opened at the date and time that are registered, or the like. Moreover, URLs to be listed can be determined by arbitrarily combining these conditions. Thus, it is possible to set a condition of listing only the URLs which satisfy all the conditions, or listing a URL if the URL meets any one of conditions, or the like.

The URL list selector 124 obtains WWW contents selected by the information processing terminal 200 from the URL list generated by the URL list generator 123. Then, the URL list selector 124 refers to the URL attached-data control table 162 generated by the cache manager 122, adds attached-information to the WWW contents if the attached-information is registered for the WWW contents, and sends it to the information processing terminal 200. If the WWW contents obtained are WWW contents with a form and data filled in the form is registered as attached-information, the URL list selector 124 embeds the data in the corresponding form in the WWW contents to send the WWW contents to the information processing terminal 200. In addition, if a file name of annotation data is registered as attached-information of WWW contents, the URL list selector 124 adds the file name to the WWW contents to send the WWW contents to the information processing terminal 200. Furthermore, if necessary, the URL list selector 124 makes the session manager 130 reproduce the annotation data corresponding to the file name and send the annotation data to the information processing terminal 200.

As shown in FIG. 1, the session manager 130 comprises a session managing section 131 and an annotation reproducer 132. The session managing section 131 assigns a session ID every session. Then, the session managing section 131 makes the cache manager 122 retain the session ID, which is assigned, with combining the session ID with a UAI given from the UAI manager 140 described later. In addition, when annotation data is added to WWW contents by the information processing terminal 200, the session managing section 131 generates an annotation data file 170 to retain the annotation data. When instructed by the URL list selector 124 to add annotation data to WWW contents, the annotation reproducer 132 reads the annotation data from the annotation data file 170 generated by the session managing section 131, and simulates the occurrence of the annotation to send its result to the information processing terminal 200.

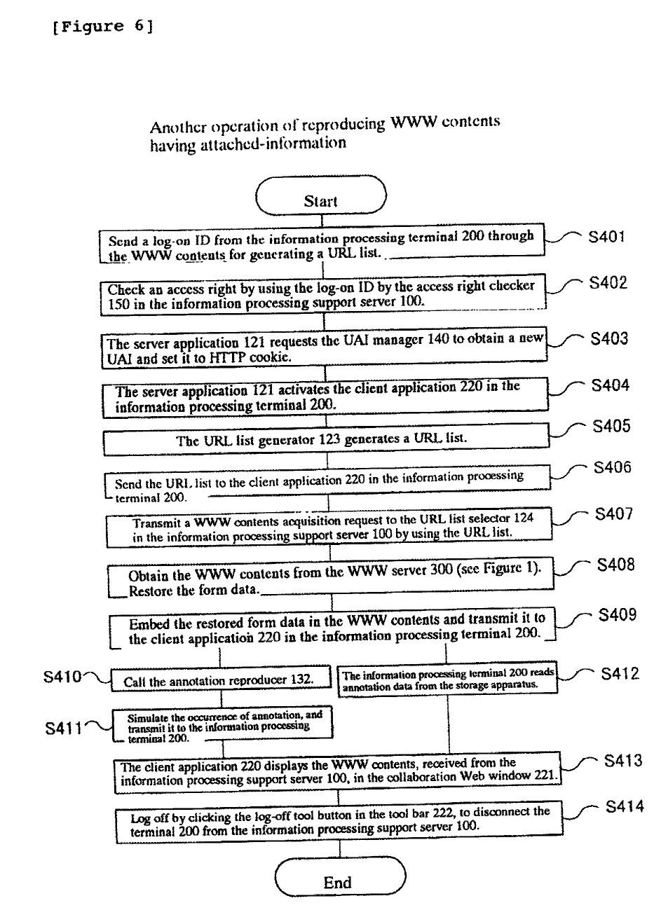

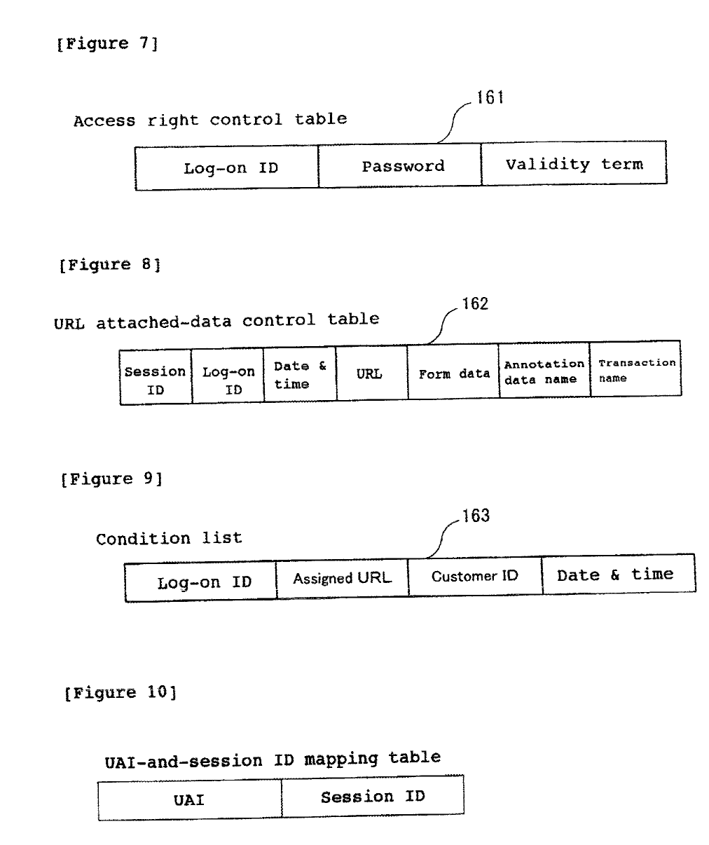

The UAI manager 140 gives a new UAI according to a request from the server application 121 when a session is started. The access right checker 150 checks the access right of a user of the information processing terminal 200, attempting to perform an access, according to a request of the server application 121 as described above. In this embodiment, the access right control table 161 is generated beforehand to be stored in a storage apparatus, which is not shown, in the information processing support server 100. As shown in FIG. 7, a log-on ID specifying a user, a password, and a validity term of an access right are registered in each line of the access right control table 161 with associating them with each other. Owing to this, the access right checker 150 refers to the access right control table 161 to judge the presence of the access right of the user on the basis of a password and a validity term that are registered with corresponding to the log-on ID of the user issuing the access request.

The information processing terminal 200 comprises a client application 220 and Web browser 230. In addition, the information processing terminal 200 can be realized with each of various household electric appliances such as a TV set embedding a computer, a game machine, portable information equipment such as a cellular phone and an electronic note, and other information terminal equipment with a communication function as well as a general computer system such as a personal computer, a workstation, a notebook computer, or the combination of them. Therefore, although this is not described in drawings, as hardware configuration, the information processing terminal 200 comprises a CPU, memory, a display unit such as a display for displaying Web-page, input devices such as a keyboard and a mouse for adding attached-information to the Web-page displayed on the display unit, and a connection interface for connecting the information processing terminal 200 to the communication network 400.

The client application 220 realizes collaboration on WWW contents that is performed between the server application 121 in the information processing support server 100 and another information processing terminal 200. Concretely, the client application 220 opens a collaboration Web window 221, where the Web-page for performing the collaboration is displayed, on a display screen of the display unit. In addition, the client application 220 displays the tool bar 222 for easily inputting commands for using various functions provided by the information processing support server 100, on the display screen. Here, the tool bar 222 provides commands in the shape of tool buttons by gathering the commands for using functions, provided by the information processing support server 100, such as performing annotation, and instructing the generation of a URL list. A user can use each of the functions by clicking a tool button, denoting a desired function, in the tool bar 222. In addition, the tool bar 222 is to support an input of a command and work on Web-page by a user, and hence, if similar functions can be provided by another method (for example, to use a menu in the collaboration Web window 221), the tool bar 222 is not an indispensable component. The client application 220 is installed in the information processing terminal 200 beforehand, or is down-loaded from the information processing support server 100 when the collaboration with another information processing terminal 200 is executed.

The Web browser 230 opens Web window on a display screen of the display unit, and displays WWW contents in the shape of Web-page. Although this is used for reference to an ordinary Web-page without any collaboration, this can be used before starting the collaboration for making the information processing support server 100 check an access right, down-loading the client application 220, and inheriting predetermined settings. Therefore, if these functions can be realized by another means (for example, to provide hot keys), the Web browser 230 is not an indispensable component.

Next, the operation of this embodiment will be described. In addition, in this operation example, such a case that an information control system according to this embodiment is applied to a Call Center is exemplified, and the operation of a case will be described, the case that a customer sends a question to an agent, who is a consultant in the Call Center, by using a predetermined WWW contents (Web-page), and the agent answers the question. Therefore, as the operation, there are the operation of the customer adding attached-information, including a question, to WWW contents, and the operation of the agent reproducing the WWW contents to which the attached-information is added by the customer.

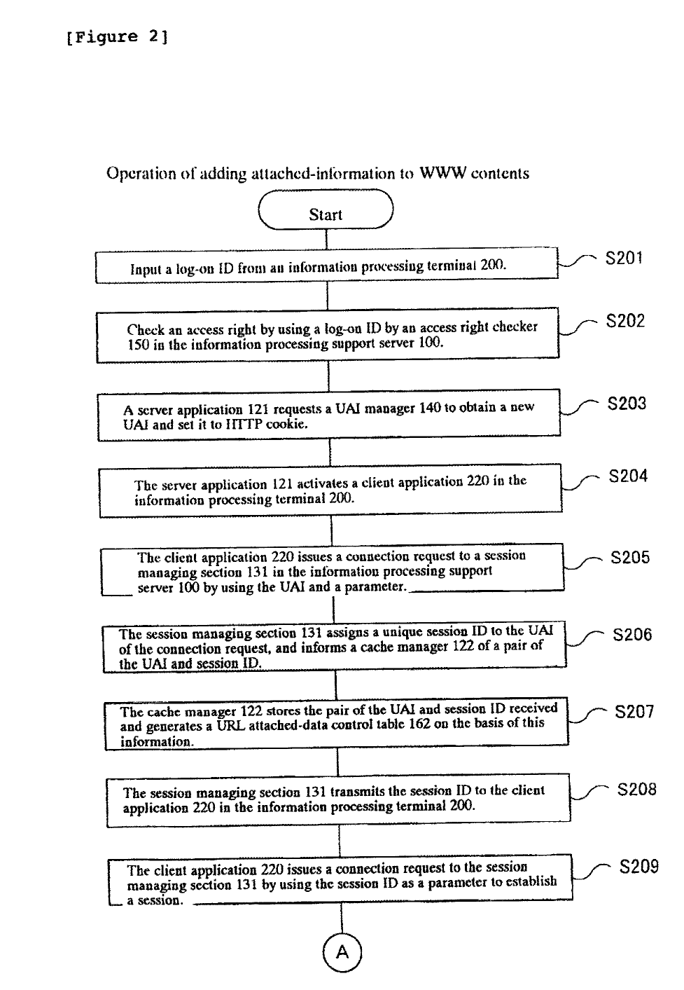

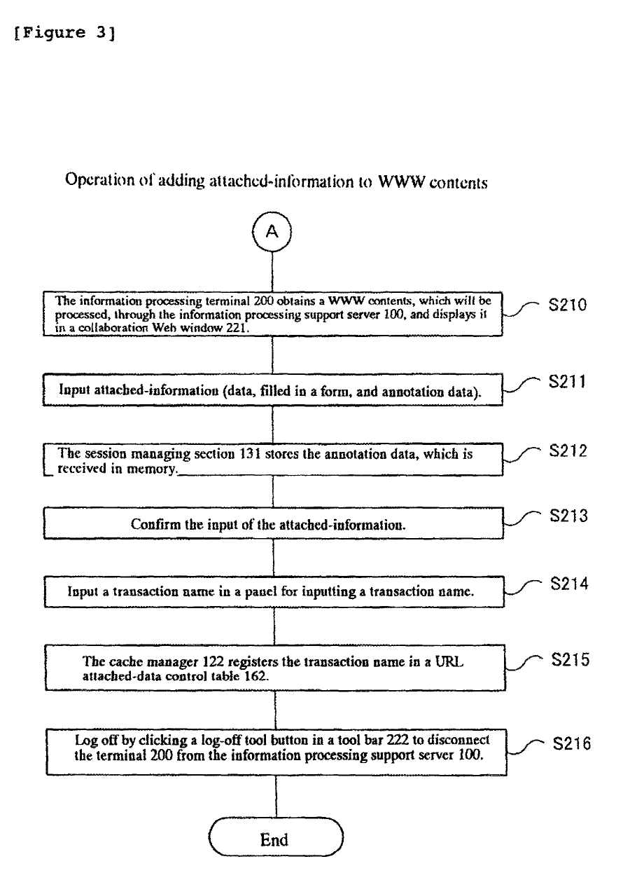

First, the operation at the time of adding the attached-information to the WWW contents will be described by using flow charts shown in FIGS. 2 and 3. This operation comprises, in rough classification, the operation of the information processing terminal 200 establishing a session with the information processing support server 100 (steps 201 to 209 shown in FIG. 2), and the operation of the information processing terminal 200 performing the work of adding the attached-information to the WWW contents that is an object of the work (steps 210 to 216 shown in FIG. 3).

First, a user who is a customer (hereinafter, this is called a customer user) sends a log-on ID to the information processing support server 100 by using the Web browser 230 in the information processing terminal 200 and the TCP/IP network 210 (step 201). Concretely, for example, with providing WWW contents for performing log-on in the information processing support server 100, the customer user accesses the WWW contents for log-on from the information processing terminal 200 to input the log-on ID.

Next, at the time of receiving the log-on ID via the TCP/IP network 110, the server application 121 in the information processing support server 100 makes the access right checker 150 check an access right of the customer user (step 202). The access right checker 150, as described above, refers to the access right control table 161 to check whether the customer user having the log-on ID has the access right. Then, if the access right is not verified, the server application 121 executes error handling, and stops its processing. If the access right of the customer user is verified, next, the server application 121 requests the UAI manager 140 to obtain a new UAI (step 203). Furthermore, the server application 121 sets the UAI, which is obtained, to an HTTP cookie.

Next, the information processing support server 100 activates the client application 220 in the information processing terminal 200 (step 204). At this time, if there is not the client application 220 in the information processing terminal 200, the information processing support server 100 transmits the client application 220 to the information processing terminal 200 to install and activate the client application 220. Owing to this, the client application 220 opens the collaboration Web window 221 on a display screen of the display unit of the information processing terminal 200 to display the tool bar 222. In addition, the client application 220 obtains the UAI from the HTTP cookie to issue a connection request to the session managing section 131 in the information processing support server 100 by using the UAI as a parameter (step 205).

Next, the session managing section 131 in the information processing support server 100 assigns a unique session ID to the UAI of the connection request received, and informs the cache manager 122 of a pair of the UAI and session ID (step 206). The cache manager 122 retains the pair of the UAI and session ID received, and generates the URL attached-data control table 162 on the basis of this information (step 207). Here, the cache manager 122 generates a table, which associates UAIs with session IDs and is shown in FIG. 10, and stores the table in the storage apparatus not shown. In addition, after informing the cache manager 122 of the pair of the UAI and session ID, the session managing section 131 transmits the session ID to the client application 220 in the information processing terminal 200 (step 208).

The client application 220 in the information processing terminal 200 newly issues a connection request to the session managing section 131 by using the session ID, received from the session managing section 131 in the information processing support server 100, as a parameter to establish a session with the information processing support server 100 (step 209).

Owing to the operation described above, a session is established between the information processing support server 100 and information processing terminal 200, and hence preparation is completed, the preparation which is for attached-information, added to WWW contents in the information processing terminal 200, being managed in the information processing support server 100.

Subsequently, the client application 220 obtains the WWW contents, where work will be performed, by the operation from the information processing terminal 200 via the information processing support server 100 to display the WWW contents in the collaboration Web window 221 (step 210). Then, the customer user inputs the attached-information (step 211). Concretely, the customer user performs, for example, filling of the fields in the form, clicking a radio button, an input of annotation data, or the like. It is possible to use functions, provided as tool buttons in the tool bar 222, for the input of the annotation data. With considering a case that the customer user asks an agent, it is possible to perform the work of writing figures such as arrows and circles, which point questionable places, by means of annotation, and filling the contents of questions in the form. In addition, it is also possible to perform the work of writing memoranda to predetermined WWW contents, used for exchanging information within himself/herself or between specific users, by means of the annotation.

In addition, if annotation data is inputted as attached-information, the annotation data is sent to the information processing support server 100 sequentially. In the information processing support server 100, the session managing section 131 retains the annotation data, which is received, in memory (step 212).

When the input of the attached-information is completed, the customer user performs the work of verifying the input of the attached-information (step 213). Concretely, if a Submit button is present in the form of the WWW contents, the customer user clicks this. In addition, the customer user clicks a tool button that ends annotation and is provided in the tool bar 222.

If the data filled in the form is submitted, the cache manager 122 in the information processing support server 100 registers the form data in the URL attached-data control table 162. Then, the cache manager 122 informs the session managing section 131. In addition, if a command ending the annotation is inputted, the session managing section 131 in the information processing support server 100 generates the annotation data file 170 not only to retain the annotation data, but also to register its file name in the URL attached-data control table 162. In addition, since the session managing section 131 always has the session ID as a parameter, it is possible to register the file name in a corresponding record of the URL attached-data control table 162 on the basis of the session ID.

If a transaction name is inputted, the client application 220 in the information processing terminal 200 displays a panel for inputting the transaction name, on a display screen, and hence the customer user inputs the transaction name on the panel (step 214). Then, the information processing terminal 200 sends the transaction name to the information processing support server 100 by the operation of clicking an OK button or the like. At the time of receiving the transaction name, the cache manager 122 in the information processing support server 100 registers the transaction name in the URL attached-data control table 162 (step 215).

In addition, if there is a field for inputting a transaction name in a form of WWW contents, the customer user can also input the transaction name at the step 211. In this case, the transaction name is registered in the URL attached-data control table 162 when the input of the attached-information is verified at the step 213.

Finally, the customer user logs off by clicking a log-off tool button in the tool bar 222 to disconnect the information processing terminal 200 from the information processing support server 100 (step 216). Owing to this, the session is closed, and the attached-information added to the WWW contents in the information processing terminal 200 is stored in the information processing support server 100.

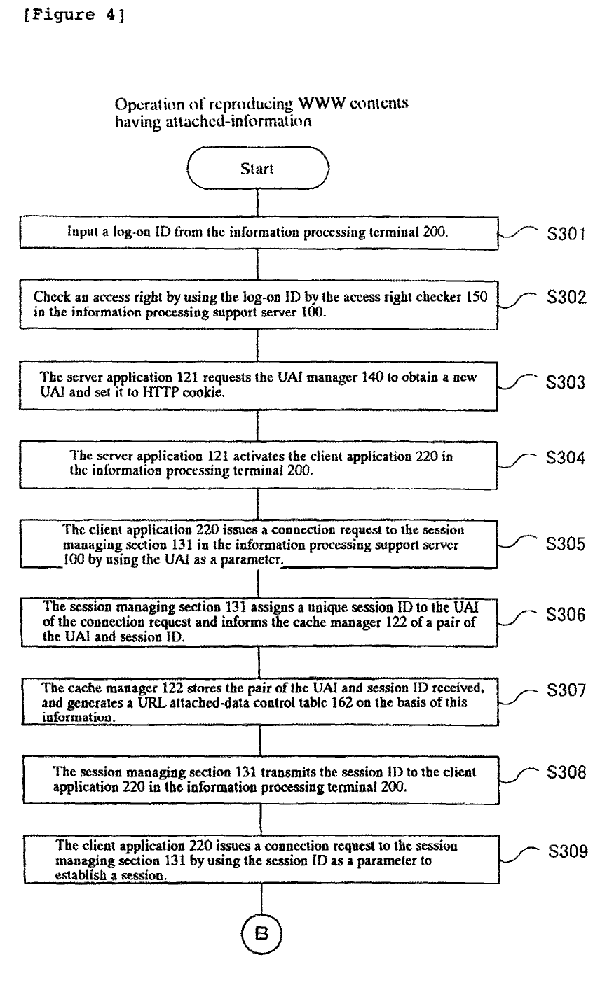

Next, the operation of reproducing www contents where attached-information is added will be described by using flow charts in FIGS. 4 to 6. In this embodiment, if the information processing support server 100 stores attached-information and the information processing terminal 200 issues an access request corresponding to the URL associated with the attached-information, the WWW contents having the URL and the attached-information associated with the URL are sent from the information processing support server 100 to the information processing terminal 200. Therefore, depending on a use style, if the information processing support server 100 stores the attached-information of the WWW contents when the information processing terminal 200 obtains a predetermined WWW contents via the information processing support server 100, it is also possible to automatically deliver the WWW contents to the information processing terminal 200 after adding the attached-information to the WWW contents. Nevertheless, here, in consideration of application to the Call Center, operation will be described, the operation of selecting a URL from a URL list so that an agent can selectively access WWW contents to which the agent should refer, that is, the WWW contents where the attached-information such as a question is added.

As methods for the information processing terminal 200 accessing the URL list, various methods can be provided, but, here, as a typical example, a method for logging on the information processing support server 100 similarly to an ordinary log-on, and a method for accessing WWW contents where the URL list is generated will be described.

The operation for accessing a URL list similarly to the ordinary log-on will be described by using FIGS. 4 and 5. This operation consists of, in rough classification, the operation of the information processing terminal 200 establishing a session with the information processing support server 100 (steps 301 to 309 shown in FIG. 4), and the operation of the information processing terminal 200 performing the work of adding attached-information to the WWW contents that is an object of the work and reproducing the WWW contents (steps 310 to 320 shown in FIG. 5).

First, an agent sends a log-on ID to the information processing support server 100 by using the Web browser 230 in the information processing terminal 200 and the TCP/IP network 210 (step 301). Concretely, similarly to the case of a customer user described above, the agent accesses the WWW contents for log-on from the information processing terminal 200 to input the log-on ID.

Next, at the time of receiving the log-on ID via the TCP/IP network 110, the server application 121 in the information processing support server 100 makes the access right checker 150 check an access right of the agent (step 302). The access right checker 150, as described above, refers to the access right control table 161 to check whether the agent having the log-on ID has the access right. Then, if the access right is not verified, the server application 121 executes error handling, and stops its processing. If the access right of the agent is verified, next, the server application 121 requests the UAI manager 140 to obtain a new UAI (step 303). Furthermore, the server application 121 sets the UAI, which is obtained, to an HTTP cookie.

Next, the information processing support server 100 activates the client application 220 in the information processing terminal 200 (step 304). At this time, if there is not the client application 220 in the information processing terminal 200, the information processing support server 100 transmits the client application 220 to the information processing terminal 200 to install and activate the client application 220. Owing to this, the client application 220 opens the collaboration Web window 221 on a display screen of the display unit of the information processing terminal 200 to display the tool bar 222. In addition, a tool button for generating a URL list is provided in the tool bar 222. Furthermore, the client application 220 obtains the UAI from the HTTP cookie to issue a connection request to the session managing section 131 in the information processing support server 100 by using the UAI as a parameter (step 305).

Next, the session managing section 131 in the information processing support server 100 assigns a unique session ID to the UAI of the connection request received, and informs the cache manager 122 of a pair of the UAI and session ID (step 306). The cache manager 122 retains the pair of the UAI and session ID received, and generates the URL attached-data control table 162 on the basis of this information (step 307). In addition, after informing the cache manager 122 of the pair of the UAI and session ID, the session managing section 131 transmits the session ID to the client application 220 in the information processing terminal 200 (step 308).

The client application 220 in the information processing terminal 200 newly issues a connection request to the session managing section 131 by using the session ID, received from the session managing section 131 in the information processing support server 100, as a parameter to establish a session with the information processing support server 100 (step 309).

Owing to the operation described above, the session is established between the information processing support server 100 and information processing terminal 200, and hence preparation is completed, the preparation which is for attached-information, to which the WWW contents are added in the information processing terminal 200, being obtained.

Subsequently, by clicking a URL list generation button in the tool bar 222 in the information processing terminal 200, a URL list generation request is transmitted from an applet, attached to this tool button, to the URL list generator 123 in the information processing support server 100 (step 310). At this time, a log-on ID is sent together as a parameter.

At the time of receiving the request, the URL list generator 123 in the information processing support server 100 refers to the condition list 163 (see FIG. 9) to generate a URL list in an HTML format on the basis of conditions suitable to the log-on ID received together with the request (step 311). Then, the URL list generator 123 sends the URL list generated, and the list selection applet, used for accessing a URL in the URL list, to the client application 220 in the information processing terminal 200 (step 312). Owing to this, the URL list is displayed in the collaboration Web window 221, and hence it is possible to select a desired URL by the agent clicking the URL.

Next, by the agent selecting the desired URL from the URL list displayed in the collaboration Web window 221 in the information processing terminal 200 and clicking the URL, WWW contents acquisition request is transmitted from the list selection applet to the URL list selector 124 in the information processing support server 100 (step 313). At this time, the session ID corresponding to the URL selected is transmitted together as a parameter.

At the time of receiving the request, the URL list selector 124 in the information processing support server 100 obtains WWW contents in the URL, which is specified, from the WWW server 300 (see FIG. 1). In addition, the URL list selector 124 refers to the URL attached-data control table 162. If there is a form in the WWW contents and form data filled in its fields is registered, the URL list selector 124 restores the form data (step 314). Then, by embedding the form data, which is restored, in the fields corresponding to the form in the WWW contents obtained, the URL list selector 124 transmits the WWW contents to the client application 220 in the information processing terminal 200 (step 315).

In addition, if a file name of the annotation data file 170 is registered when the URL list selector 124 refers to the URL attached-data control table 162, it is necessary to make the information processing terminal 200 obtain the annotation data, for which there are two methods.

One is a method for supplying the annotation data from the information processing support server 100. In this case, first, the URL list selector 124 calls the annotation reproducer 132 in the session manager 130 with a session ID as a parameter (step 316). The annotation reproducer 132 refers to the annotation data file 170 to simulate the occurrence of annotation. Then, the annotation reproducer 132 transmits the annotation data to the information processing terminal 200, which is operating, via a session specified by the session ID (step 317).

Another is a method for obtaining the annotation data from an apparatus except the information processing support server 100. This requires that the annotation data is stored in a storage apparatus, which is accessible, such as an external storage apparatus connected to the information processing terminal 200. In this case, the information processing support server 100 sends only the file name of the annotation data file 170 with the WWW contents to the information processing terminal 200. Then, the information processing terminal 200 reads the annotation data file 170, specified by the file name received, from the storage apparatus (step 318).

These two methods can also be compositely used according to an operating environment of the information processing terminal 200 instead of using any one of these methods.

Next, the client application 220 in the information processing terminal 200 displays the WWW contents, received from the information processing support server 100, in the collaboration Web window 221 (step 319). If annotation data is added to the WWW contents, the client application 220 reproduces the annotation, and synthesizes and displays the annotation with the WWW contents.

Finally, the agent logs off by clicking a log-off tool button in the tool bar 222 to disconnect the information processing terminal 200 from the information processing support server 100 (step 320). In addition, before closing the session, it is also possible to perform editing work of the form data and annotation data such as addition, deletion, and modification. In this case, the attached-information added to the WWW contents is stored in the information processing support server 100 as a new transaction that is associated with the session ID assigned at the step 306.

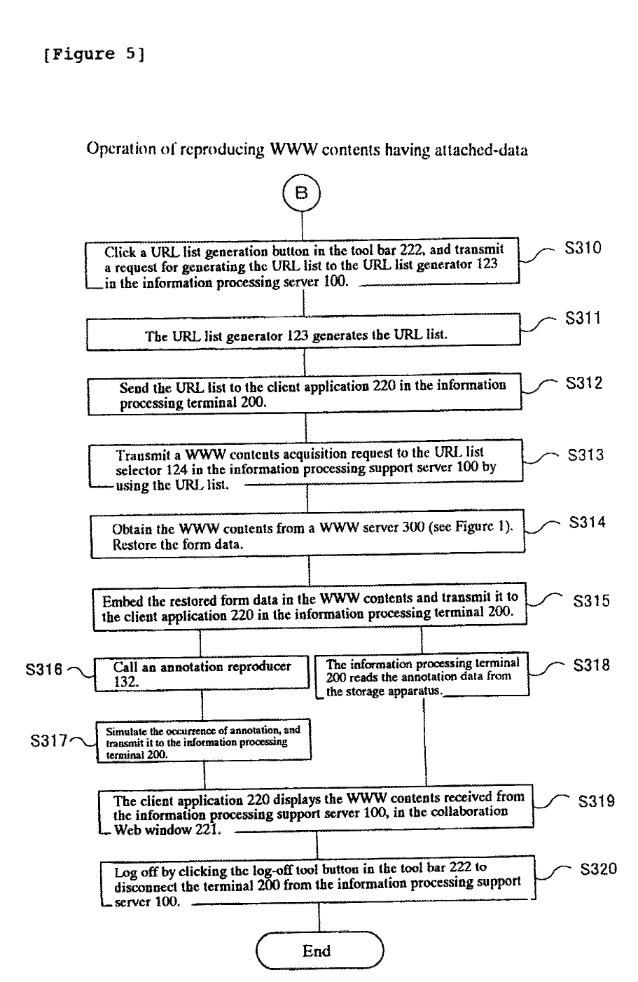

Next, the operation of accessing WWW contents for generating a URL list will be described with reference to FIG. 6. In this operation, since log-on is performed from a special URL list generation WWW contents, a session is established at the time of accessing the URL list generation WWW contents. Therefore, the operation for establishing the session is not performed in the operation after the log-on shown in FIG. 6.

First, an agent accesses the URL list generation WWW contents provided in the information processing support server 100 by using the Web browser 230 in the information processing terminal 200 and the TCP/IP network 210 to send a log-on ID (step 401).

Next, at the time of receiving the log-on ID via the TCP/IP network 110, the server application 121 in the information processing support server 100 makes the access right checker 150 check an access right of the agent (step 402). The access right checker 150, as described above, refers to the access right control table 161 to check whether the agent having the log-on ID has the access right. Then, if the access right is not verified, the server application 121 executes error handling, and stops its processing. If the access right of the agent is verified, next, the server application 121 requests the UAI manager 140 to obtain a new UAI (step 403). Furthermore, the server application 121 sets the UAI, which is obtained, to an HTTP cookie.

Next, the information processing support server 100 activates the client application 220 in the information processing terminal 200 (step 404). At this time, if there is not the client application 220 in the information processing terminal 200, the information processing support server 100 transmits the client application 220 to the information processing terminal 200 to install and activate the client application 220. Owing to this, the client application 220 opens the collaboration Web window 221 on a display screen of the display unit of the information processing terminal 200.

In addition, after recognizing that it is the log-on from the URL list generation WWW contents, the URL list generator 123 in the information processing support server 100 refers to the condition list 163 to generate a URL list in an HTML format on the basis of conditions suitable to the log-on ID (step 405). Then, the URL list generator 123 sends the URL list generated, and the list selection applet, used for accessing a URL in the URL list, to the client application 220 in the information processing terminal 200 (step 406). Owing to this, the URL list is displayed in the collaboration Web window 221, and hence it becomes possible to select a desired URL by the agent clicking the URL.

Since the operation after this is the same as the operation after the step 313 that is described by using FIG. 3, its description will be omitted.

As described above, according to this embodiment, attached-information added to WWW contents is stored in the information processing support server 100. Therefore, it is possible to separate the operation in the information processing terminal 200 into the work of adding the attached-information to the WWW contents and the work of reproducing the WWW contents to which the attached-information is added. Thus, if this embodiment is applied to collaboration by a plurality of information processing terminals 200, it is not necessary that all the information processing terminals 200, which participate in the collaboration, establish sessions at the same time. Therefore, if this embodiment is applied to the customer counseling service, customer users can access the information processing support server 100 at arbitrary time, and can add questions or the like. Furthermore, agents can access the information processing support server 100 and can verify the questions or the like that are added to the WWW contents at any time.

In addition, since it is possible to automatically sort agents, accessing WWW contents specified by the URLs, when a URL list is generated, it is not necessary to perform complicated work such as the work of fully reading and understanding electronic mails, and transmitting the electronic mails to suitable agents respectively, like a case of using the electronic mails.

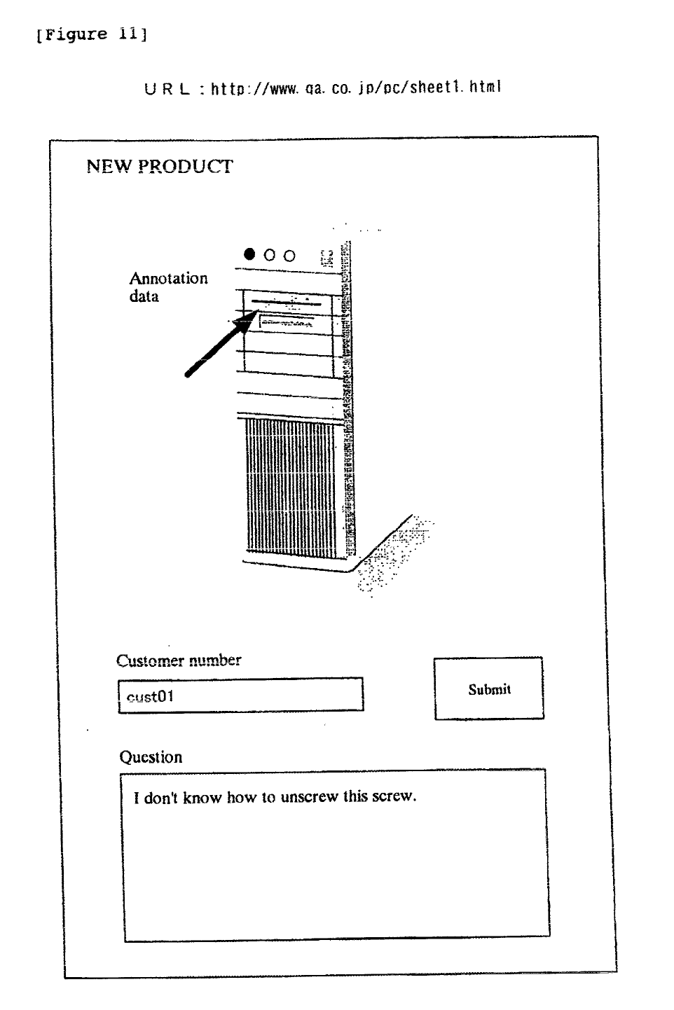

Next, such a concrete embodiment that this embodiment is applied to a system in a Call Center will be described by using FIGS. 11 to 13. Here, it is assumed that an object is WWW contents having a URL of “http://www.qa.co.jp/pc/sheet1.html” and a customer user inputted attached-information.

With referring to FIG. 11 showing the WWW contents (Web-page) in such a state that the customer user inputted the attached-information, an arrow showing a specific position in an image of Web-page is written as annotation data. In addition, an input field of a “customer number” specifying a customer user and an input field of questions are provided as fields of a form, and text data is entered respectively.

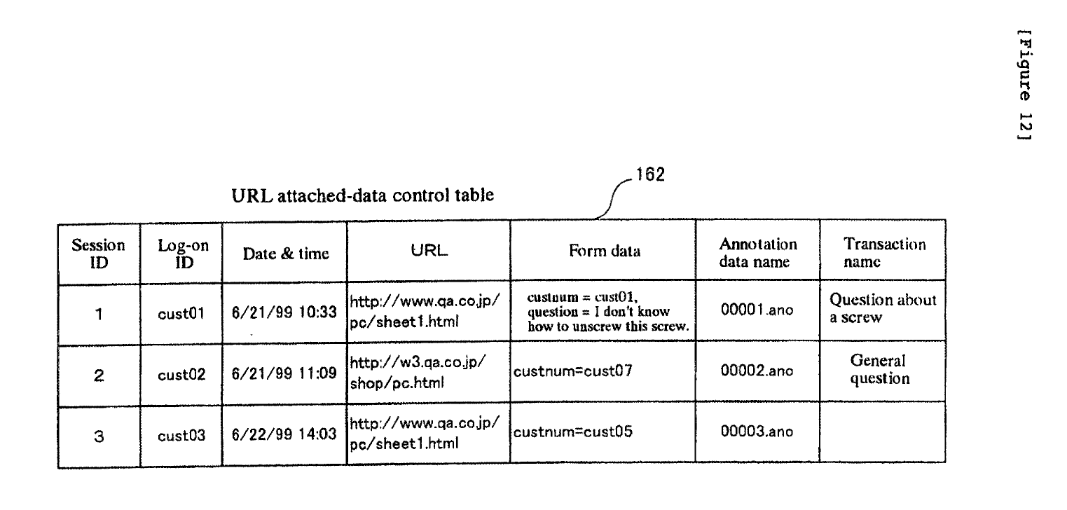

In this case, if inputs of these attached-information are verified in the information processing terminal 200 (see the step 213 in FIG. 3), the contents of the URL attached-data control table 162 stored in the information processing support server 100 become as shown in FIG. 12. With referring to FIG. 12, respective items such as log-on IDs, dates and times when the sessions were opened, URLs of WWW contents, form data, file names of annotation data, and transaction names in regard to sessions whose session IDs are 1, 2, and 3 are registered. The session whose session ID is 1 corresponds to the Web-page shown in FIG. 11. Then, the URL “http://www.qa.co.jp/pc/sheetl.html” of the WWW contents is registered in a URL column together with a tag (“custnum,” “question”), text data filled in the form is registered in a form data column, and a file name “00001.ano” of the annotation data file 170 is registered in a annotation data name column. In addition, in a transaction name column, a name “question about a screw” is registered. Furthermore, since the transaction name is not an indispensable input item, nothing is inputted in the transaction name column of the session ID 3.

Next, if an agent operates the information processing terminal 200 so as to access the information processing support server 100 from the information processing terminal 200 and generate a URL list, the collaboration Web window 221 is opened in the display unit of the information processing terminal 200, and the URL list as shown in FIG. 13 is displayed. In the URL list in FIG. 13, selection items 1301, 1302, and 1303, in each of which a session date and time and a customer number are displayed, are displayed. These selection items 1301, 1302, and 1303 are linked to the WWW contents having the corresponding URLs. Therefore, the user can access corresponding WWW contents by clicking an arbitrary selection item in the URL list.

In addition, it is assumed that the agent has an access right to all the sessions shown in FIG. 12. Therefore, in the URL list shown in FIG. 13, all of the three sessions registered in the URL attached-data control table 162 shown in FIG. 12 are listed. In FIG. 12, since a question (attached-information) in the session 1 and a question (attached-information) in the session 3 are about the same WWW contents, they are displayed in a lot with binding them with the URL. In this manner, a URL list is not always linked only to URLs, but it is possible to flexibly design the URL list so that users can easily watch or can easily operate the URL list. In addition, as shown in FIG. 12, a URL list itself is given a URL different from the WWW contents shown in FIG. 11.

If the agent clicks the selection item 1301 “6/21/99 10:33 Customer Number: cust01” in the URL list at a phase of displaying the URL list shown in FIG. 13, the Web-page where the annotation data and form data are reproduced as shown in FIG. 11 is displayed.

In the above-described embodiments and their operation examples, it is assumed that the information processing terminal 200 obtains WWW contents via the information processing support server 100, and, at that time, attached-information is added to the WWW contents in the information processing support server 100. Concretely, if the attached-information is form data, the information processing support server 100 embeds text data corresponding to the form of the WWW contents to transmit the WWW contents to the information processing terminal 200. In addition, if the attached-information is annotation data, the information processing support server 100 transmits the WWW contents, and the annotation data or a file name of the annotation data to the information processing terminal 200.

Nevertheless, WWW contents can also be directly obtained by the information processing terminal 200 from the WWW server 300. In this case, the information processing support server 100 returns only a URL, corresponding to the access request, and attached-information associated with the URL to the information processing terminal 200. In the information processing terminal 200, WWW contents acquisition request having the URL is automatically generated. With corresponding to this request, the WWW contents having the URL is transmitted from the WWW server 300 to the information processing terminal 200. The information processing terminal 200 synthesizes the WWW contents, which are obtained in this manner, and the attached-information of the WWW contents, and displays the WWW contents, which are synthesized, in the collaboration Web window 221.

As described above, since this embodiment adds attached-information to WWW contents, even the customer users not having each electronic mail address can transmit questions to agents so long as service is provided as the WWW contents. In addition, since it is possible to perform direct drawing on WWW contents by means of annotation, it is possible to easily understand the contents of questions differently from questions in sentences written in electronic mails.

Furthermore, it is possible to use this embodiment for simple information exchange among members without any mail system. Concretely, it is also possible to use this embodiment in such a form that a plurality of members, who will travel together, access WWW contents for providing information relating to travels and write information respectively to exchange information.

As described above, according to the present invention, it becomes possible that a plurality of users share information added to WWW contents, and to refer to and modify WWW contents with attached-information at any time.

In addition, it is possible to automatically deliver WWW contents with attached-information to predetermined users.

Furthermore, it is possible that a user accesses WWW contents with attached-information by using a URL list.

1. An information control system supporting collaboration for a plurality of information processing terminals that treat a Web content, comprising:
an information processing support server connected to a Web server via a communication network; and
the plurality of information processing terminals that obtain a Web content provided by the Web server via the information processing support server and perform work using the Web content, the plurality of information processing terminals each comprising:
an attached-information adding-section adding predetermined attached-information to the Web content obtained, the information processing support server comprising:
an attached-information managing-section retaining attached-information, added to the Web content by the information processing terminal, and a URL of the Web content with associating them with each other; and
an attached-information transmitter transmitting the Web content, having the URL, and the attached-information, associated with the URL, to the information processing terminal if an access request from the information processing terminal corresponds to the URL retained in the attached-information managing-section.

2. The information control system according to claim 1, wherein:
the information control system includes at least annotation data for performing drawing on a Web content as the attached-information;
in the information processing support server, the attached-information managing-section associates a URL of the Web content with a file name of the annotation data;
the attached-information transmitter transmits the Web content relating to an access request and the annotation data specified with the file name associated with the URL of the Web content to the information processing terminal according to the access request from the information processing terminal; and
wherein the information processing terminal synthesizes and displays the Web content and annotation data by using a browser.

3. The information control system according to claim 1, wherein:
the information control system includes at least data filled in a form for the Web content as the attached-information;
in the information processing support server, the attached-information managing-section associates a URL of the Web content with the data itself filled in the form, and the attached-information transmitter embeds the data, which is associated with the URL of the Web content, in a form of the Web content relating to an access request according to the access request from the information processing terminal and transmits the Web content to the information processing terminal; and
the information processing terminal displays the Web content, in the form of which the filled data is embedded, by using a browser.

4. The information control system according to claim 1, wherein the information processing support server further comprises:
a URL list generator generating a URL list of the Web content, where the attached-information is added, according to a request from the information processing terminal; and
a URL list transmitting the URL list, which is generated, to the information processing terminal.

5. The information control system according to claim 4, wherein:
the URL list generator in the information processing support server generates the URL list as a Web content; and
the information processing terminal requests the information processing support server to obtain the Web content, where the attached-information is added, by clicking a desired URL in the URL list provided as the Web content.

6. The information control system according to claim 4, wherein the URL list generator in the information processing support server recognizes a user of the information processing terminal, and generates the URL list of the Web content that the user can access.

7. The information control system according to claim 6, wherein the URL list generator in the information processing support server sets the Web content, which the user can access, on the basis of a kind of the Web content or contents of attached-information.

8. An information control system supporting collaboration for a plurality of information processing terminals that treat a Web content, comprising:
the plurality of information processing terminals each of which is connected to Web server via a communication network, obtains a Web content provided by the Web server, and adds predetermined attached-information as work for the Web content; and
an information processing support server that associates the attached-information, added to the Web content by the information processing terminal, with a URL of the Web content and retains them,
the information processing support server returning the attached-information corresponding to an access request to the information processing terminal when receiving the access request, corresponding to a URL associated with the attached-information, from the information processing terminal, and
the information processing terminal that receives the attached-information from the information processing support server, obtains the Web content having the URL corresponding to the access request from the Web server, and synthesizes the attached-information and the Web content.

9. An information processing support server supporting collaboration for a plurality of information processing terminals that treat a Web content, comprising:
a cache manager that obtains the Web content from Web server, connected to a communication network, according to an access request from the information processing terminal, and further transmits the Web content, which are obtained, to the information processing terminal having issued the access request; and
a session information controller that recognizes start of a session by the information processing terminal owing to the access request received from the information processing terminal, manages session information including a URL of the Web content that will be processed in the session, receives attached-information added to the Web content by the information processing terminal, associates the session information with the attached-information, and manages them.

10. The information processing support server according to claim 9, wherein the session information controller allows a transmission and receiving section to transmit the Web content with a URL, included in the session information, and the attached-information, associated with the session information, to the information processing terminal if an access request from the information processing terminal corresponds to the session information in the session recognized.

11. The information processing support server according to claim 10, wherein the session information controller embeds filled data in a form of a Web content and allows the transmission and receiving section to transmit transmits the Web content to the information processing terminal if the Web content obtained in the session recognized are a Web content with a form, and the filled data in the form is associated with its URL as the attached-information.

12. The information processing support server according to claim 10, further comprising a URL list generator generating a URL list of the Web content as a Web content, to which the attached-information is added, according to a request from the information processing terminal, wherein the cache manager returns the URL list, generated by the URL list generator, to the information processing terminal.

13. An information processing terminal comprising:
a connecting section for transmitting and receiving data including a Web content with being connected to Web server; and
a browser that displays a Web content received from the server via the connecting section, adds predetermined attached-information to the Web content displayed, and transmits the Web content to the server via the connecting section,
the browser being capable of synthesizing and displaying the Web content and annotation data if data received from the server is the Web content and the annotation data as attached-information added to the Web content.

14. The information processing terminal according to claim 13, wherein the browser obtains annotation data by using a file name, synthesizes the Web content and annotation data, and displays them if data received from the server is the Web content and the file name of the annotation data as attached-information added to the Web content, and the annotation data can be obtained from predetermined storage apparatus except the server.

15. An information processing terminal comprising:
a connecting section for transmitting and receiving data including a Web content by being connected to a server via a communication network;
a synthesis processor that obtains a Web content with a URL via the communication network and synthesizes the Web content and the attached-information at the time of receiving the attached-information, associated with the predetermined URL, from the server via the connecting section; and
a browser that displays the Web content, which are received from the server via the connecting processor and with which the attached-information is synthesized by the synthesis processor, adds predetermined attached-information to the Web content displayed, and transmits the Web content to the server via the connecting section.

16. An information processing method for supporting collaboration for a plurality of information processing terminals that treat a Web content, comprising the steps of:
adding predetermined attached-information to the Web content;
associating the attached-information, added to the Web content, with a URL of the Web content and retaining them; and
transmitting the Web content with the URL and the attached-information associated with the URL to the source of an access request according to the access request corresponding to the URL associated with the attached-information.

17. The information processing method according to claim 16,
wherein at least annotation data for performing drawing on the Web content is included as the attached-information at the step of adding the attached-information;
wherein the step of retaining the attached-information includes a step of generating a data file after receiving the annotation data and associating a file name of the data file with a URL of the Web content if the attached-information is the annotation data; and
wherein the step of adding the attached-information to a Web content includes a step of adding a data file of the annotation data specified by the file name to the Web content if information associated with the URL is the file name of the annotation data, and
further including a step of synthesizing the Web content and the annotation data at the time of displaying the Web content.

18. The information processing method according to claim 16,
wherein at least data filled in a form of the Web content is included as the attached-information at the step of adding attached-information;
wherein the step of retaining attached-information includes a step of associating the data itself with the Web content if the attached-information is the data filled in the form; and
wherein the step of adding the attached-information to a Web content includes a step of embedding the data, filled in the form, in a concerned place of the Web content having the form if information associated with the URL is the data filled in the form.

19. The information processing method according to claim 16, wherein, before the step of adding attached-information, the information processing method further comprises a step of generating a URL list of the Web content having attached-information associated at the step of retaining attached-information.

20. The information processing method according to claim 19, wherein the step of generating a URL list comprises the steps of:
recognizing a user of the information processing terminal; and
generating the URL list of the Web content that the user can access.

21. A storage that stores an information processing program executed by a computer so that input means of the computer can read the information processing program, the storage storing the information processing program making the computer execute:
processing of obtaining a Web content from Web server, connected to a communication network, according to an access request from an information processing terminal and transmitting the Web content to the information processing terminal having issued the access request;
processing of receiving attached-information added to the Web content by the information processing terminal and retaining the attached-information and a URL of the Web content with associating them with each other; and
processing of transmitting the Web content, having the URL, and the attached-information, associated with the URL, to the information processing terminal if an access request from the information processing terminal corresponds to the URL associated with the attached-information.

22. A storage that stores an information processing program executed by an information processing terminal so that an input unit of the information processing terminal can read the information processing program, the storage storing the information processing program making the information processing terminal execute:
processing of receiving a Web content from a server;
processing of synthesizing the Web content and annotation data if the annotation data is added to the Web content received from the server;
processing of adding predetermined attached-information to the Web content displayed; and
processing of transmitting the attached-information, which is added, to the server.

23. A storage that stores an information processing program executed by an information processing terminal so that an input unit of the information processing terminal can read the information processing program, the storage storing the information processing program making the information processing terminal execute:
processing of receiving attached-information associated with a predetermined URL by a server;
processing of obtaining a Web content having the URL corresponding to the attached-information received;
processing of synthesizing the Web content and the attached-information obtained; and
processing of displaying the Web content where the attached-information is synthesized.

24. A program transmission apparatus comprising:
a storage unit for storing a program making an information processing terminal execute: processing of receiving a Web content from a server; processing of synthesizing the Web content and annotation data if the annotation data is added to the Web content received from the server; processing of adding predetermined attached-information to the Web content displayed; and processing of transmitting the attached-information, which is added, to the server; and
a transmission unit for reading the program from the storage means and transmitting the program.

25. An information control system that comprises a plurality of information processing terminals and an information processing support server supporting collaboration for the plurality of information processing terminals that treat a Web content, the information processing support server comprising:
a storage unit for storing a program executed by the plurality of information processing terminals; and
a transmission unit for reading the program from the storage unit according to a request from the information processing terminal and transmitting the program,
the program, which is stored in the storage unit , making the information processing terminal execute: processing of receiving and displaying the Web content; processing of adding predetermined attached-information to the Web content displayed; processing of transmitting the attached-information, which is added, to the information processing support server; and processing of synthesizing the Web content and annotation data at the time of receiving the Web content and the annotation data associated with the Web content.
